(19) United States
(12) Patent Application Publication
(10) Pub. No.: US 2004/0126234 A1
(43) Pub. Date: Jul. 1, 2004

(54) Fan frame structure

(75) Inventor: Fu-Yin Wang, Taipei (TW)

Correspondence Address: TROXELL LAW OFFICE PLLC, SUITE 1404, 5205 LEESBURG PIKE, FALLS CHURCH, VA, 22041, US

(73) Assignee: Datech Technology Co., Ltd.

(21) Appl. No.: 10/731,508

(22) Filed: Dec. 10, 2003

(30) Foreign Application Priority Data
Dec. 31, 2002 (TW) 091221686

(51) Int. Cl. F03B 1/00

(52) U.S. Cl. 415/220

(57) ABSTRACT

The present invention relates to an improvement in the fan frame structure of an electrical fan, with the structure of the fan at least comprising a fan frame with a central part forming a socket for the fan, one fan wheel with a central axis and one motor mounted on the before mentioned socket, with the central hole taking in the axis of the fan wheel. Between the fan frame and its socket there is a supporting part. This supporting part is used to fix the position of the socket on the central part of the fan frame. The fan motor consists of a stator attached to the socked and a rotor connected the axis of the fan wheel. On one side of the supporting part of the fan frame there is a desired area with collective-wire channel. The power cables of the motor can run through collective-wire channel. This allows the power cables of the motor to be easily inserted, fitted and secured onto the fan frame structure.

### FIELD OF THE INVENTION

The present invention relates to an improvement in the fan frame structure of an electrical fan. More specifically the invention makes use of collective-wire channel in the fan frame, enabling the power cables of the motor of the electrical fan to be inserted into the collective-wire channel, therefore allowing the power cables of the motor to be easily inserted, fitted and secured onto the fan frame structure.

### BACKGROUND OF THE INVENTION

The frame 4 of conventional electrical fans (as shown on FIG. 5) used for reference makes use of a socket 41. Between the fan frame 4 and its socket 41 there is an upward facing supporting part 42. This upward facing supporting part 42 is used to fix the position of the socket 41 in the center of the fan frame 4. The supporting part on the outer edge of the fan frame 4 possesses a cable slit 43. The power cables 51 of the motor 5 can be fitted into this cable slit 43. Thus the power cables 51 of the motor 5 are securely contained within. The above mentioned fan frame 4 can of course allow the power cables 51 of the motor 5 to be securely contained within the cable slit 43, but between the connection point of the power cables 51 with the motor 5 and the cable slit 43, there is still a distance B. We assume the case that there is no additional securing for the power cables 51 in the stretch B. Even if the power cables 51 are securely contained within the cable slit 43, the power cables 51 are still not secured in the stretch B between the cable slit 43 and the connection point of the motor 5 and can therefore move loosely. Thus the possibility of the power cables 51 leaving the secure positions in the cable slit 43 is given. Conventional structures make use of a fastening strip 6 (or plastic band) to solve this problem. In the stretch B, the power cables 51 are tied to the supporting part 42 of the fan frame 4. This method gives additional securing to the power cables 51 in the stretch B. But given the case that the motor 5 has a defect or is damaged in any way and has to be repaired or replaced, the fastening strip 6 (or plastic band) has to be cut to take down the motor 5 of the electrical fan. After the motor 5 of the electrical fan has been repaired or replaced it has to be put back into the structure. At this time you have to use another fastening strip 6 (or plastic band) to tie the power cables 51 in the stretch B onto the supporting part 42. The possibility of causing confusion or damage to the power cables 51 while taking the structure apart or putting it together is high, therefore the above mentioned structure does not meet the demands for a secure and easy to use structure.

### SUMMARY OF THE INVENTION

The main purpose of the present invention is to achieve the goal of inserting the power cables of the motor easily into the collective-wire channel on the fan frame.

Another purpose of the present invention is to achieve the goal of keeping the power cables of the motor secure in the collective-wire channel on the fan frame.

A third purpose of the present invention is to achieve the goal of securing the power cables of the motor in the collective-wire channel on the fan frame.

To achieve the above mentioned goals, the present invention makes use of an improvement in the fan frame structure, with the structure of the fan at least comprising a fan frame with a central part forming a socket for the fan, one fan wheel with a central axis and one motor mounted on the before mentioned socket, with the central hole taking in the axis of the fan wheel. Between the fan frame and its socket there is a supporting part. This supporting part is used to fix the position of the socket on the central part of the fan frame. The motor structure consists of a stator attached to the before mentioned socket and a rotor connected the axis of the fan wheel.

On one side of the supporting part of the fan frame there is a desired area with collective-wire channel. The power cables of the motor can run through collective-wire channel. This allows the power cables of the motor to be easily inserted, fitted and secured onto the fan frame structure.

### BRIEF DESCRIPTION OF THE DRAWINGS

The present invention may best be understood through the following description with reference to the accompanying drawings, in which:

FIG. 1 is a view showing the fan parts separated according to the present invention;

FIG. 2 is a front view of the fan frame structure according to the present invention;

FIG. 3 is the enlarged detail view of the part of the present invention labelled A-A in FIG. 2;

FIG. 4 is a view showing the collective-wire channel in use according to the present invention; and

FIG. 5 is a view showing the insertion of the power cables into the fan frame structure according to the conventional invention.

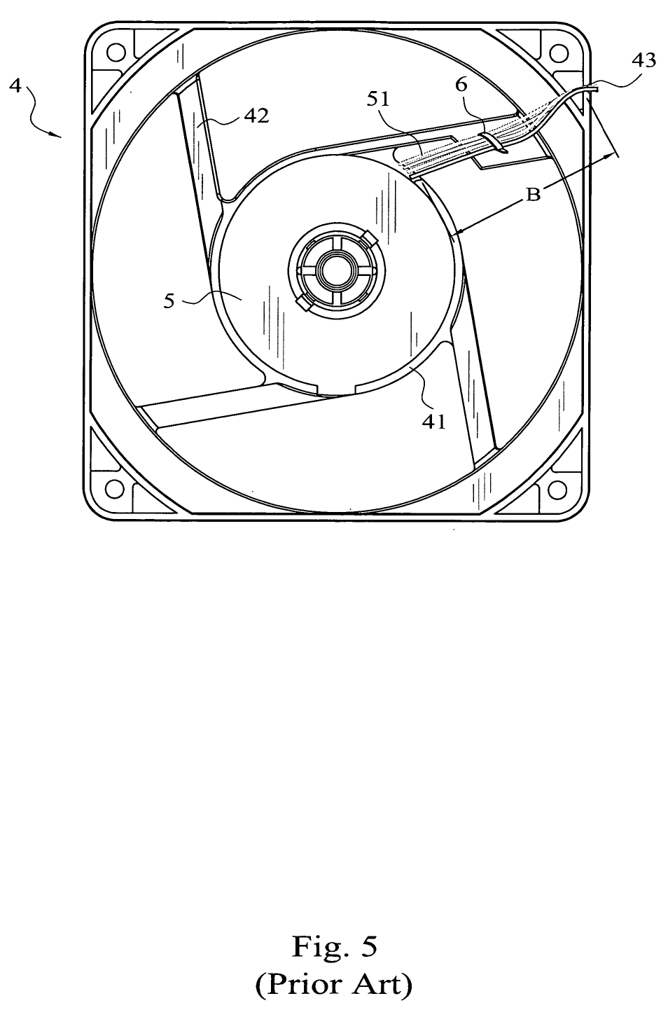

### DETAILED DESCRIPTION OF THE PREFERRED EMBODIMENT

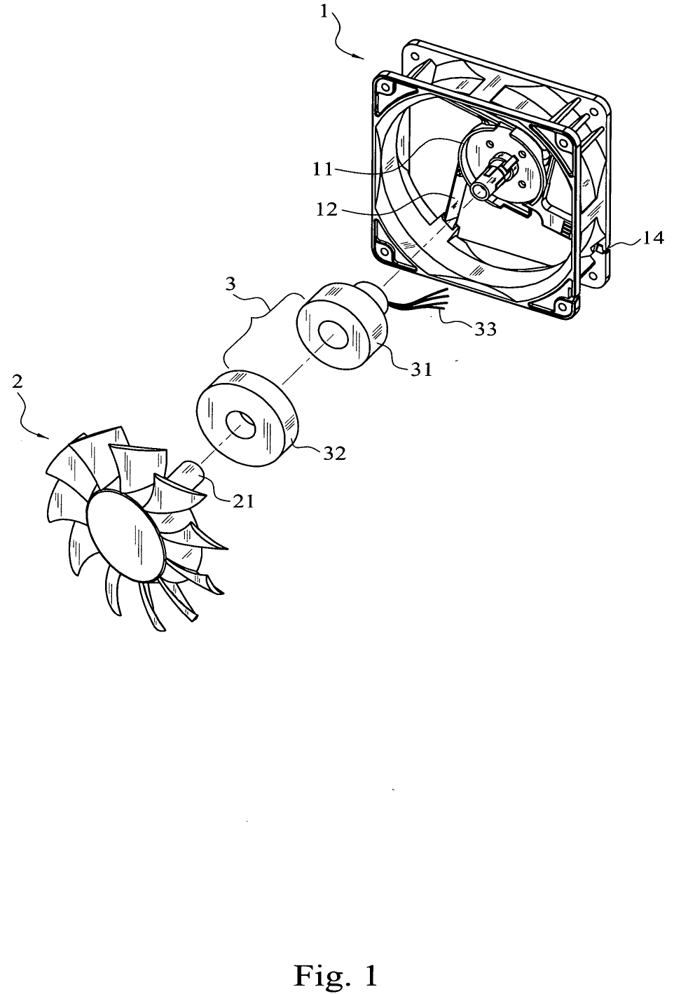

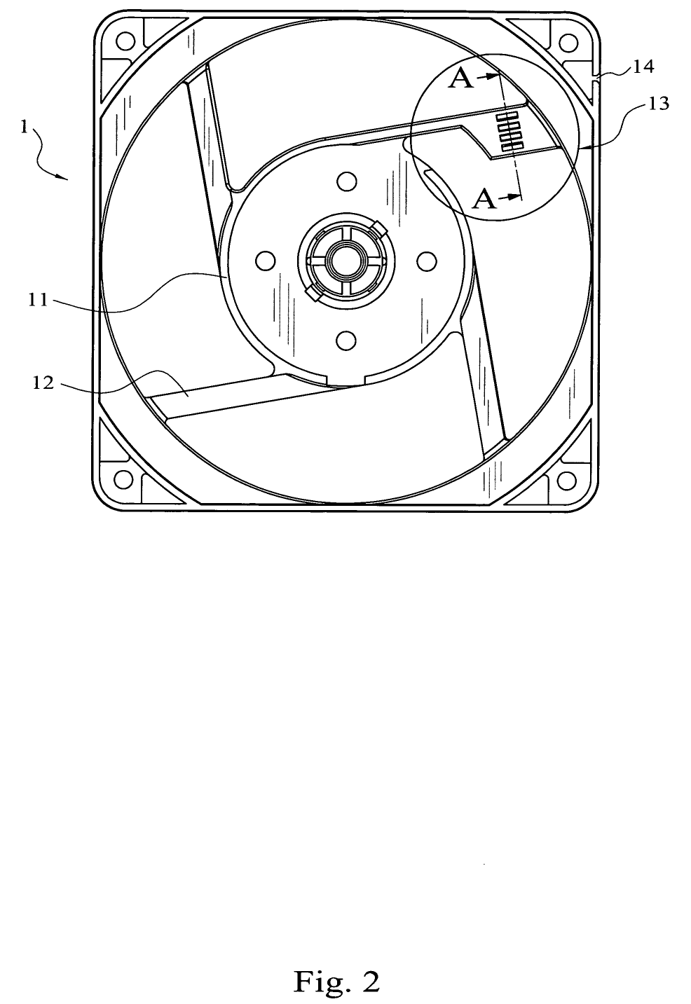

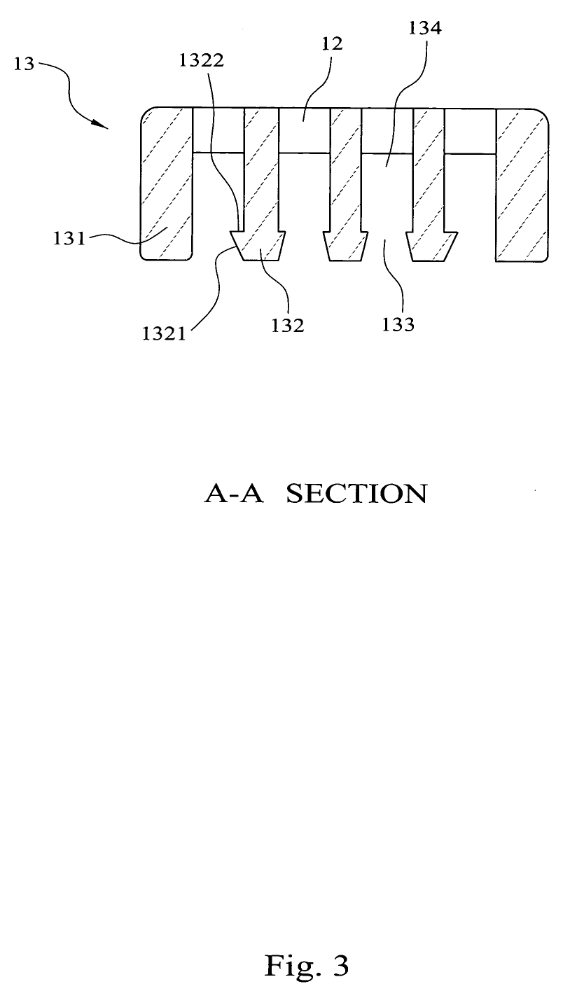

The present invention will now be described more specifically with reference to the following embodiments. Please refer to FIG. 1, FIG. 2 and FIG. 3. These drawings show fan parts according to the present invention, with parts separated, a front view of the fan fame structure of the present invention and the enlarged detail view of the part of the present invention labelled A-A in FIG. 2. The pictures show that the present invention refers to an improvement in the frame structure of an electrical fan. The fan structure consists of a fan frame 1, a fan wheel 2, a motor 3 and collective-wire channel 13 on the fan frame 1. The power cables 33 of the motor 3 can run through collective-wire channel 13, allowing them to be easily inserted, fitted and secured onto the fan frame 1.

The above mentioned fan comprises a fan frame 1 with a central part forming a socket 11 for the fan, one fan wheel 2 with a central axis 21 and one motor 3 mounted on the before mentioned socket 11, with the central hole taking in the axis 21 of the fan wheel 2. Between the fan frame 1 and its socket 11 there is a supporting part 12. This supporting part 12 is used to fix the position of the socket 11 on the central part of the fan frame 1.

There is a cable slit 14 on the outer edge of the fan frame 1. The motor structure 3 consists of a stator 31 attached to the before mentioned socket 11 and a rotor 32 into which the axis 21 of the fan wheel 2 is fitted. The motor 3 has got a power connection point with several power cables 33 attached to. On one side of the supporting part of the fan frame 1 there is a desired area 12 with collective-wire channel 13. The collective-wire channel 13 comprises two side walls 131 protruding from the desired area 12. In between these side walls 131 there are securing walls 132. The two side walls 131 and the securing walls 132 are arranged in regular distances. Therefore, regular slits will form openings 133 in the free spaces between the two side walls 131 and the securing walls 132. The space contained between these walls forms one restricted area 134. The restricted area 134 which is contained between the two side walls 131 and the securing walls 132 can take in the power cables 33 of the motor 3. Both sides of the outer edge of the securing walls 132 have bevels 1321, through which a hook-like surface 1322 is formed towards the contained free space. Through these features, the present structure presents a completely new improvement for the fan frame structure.

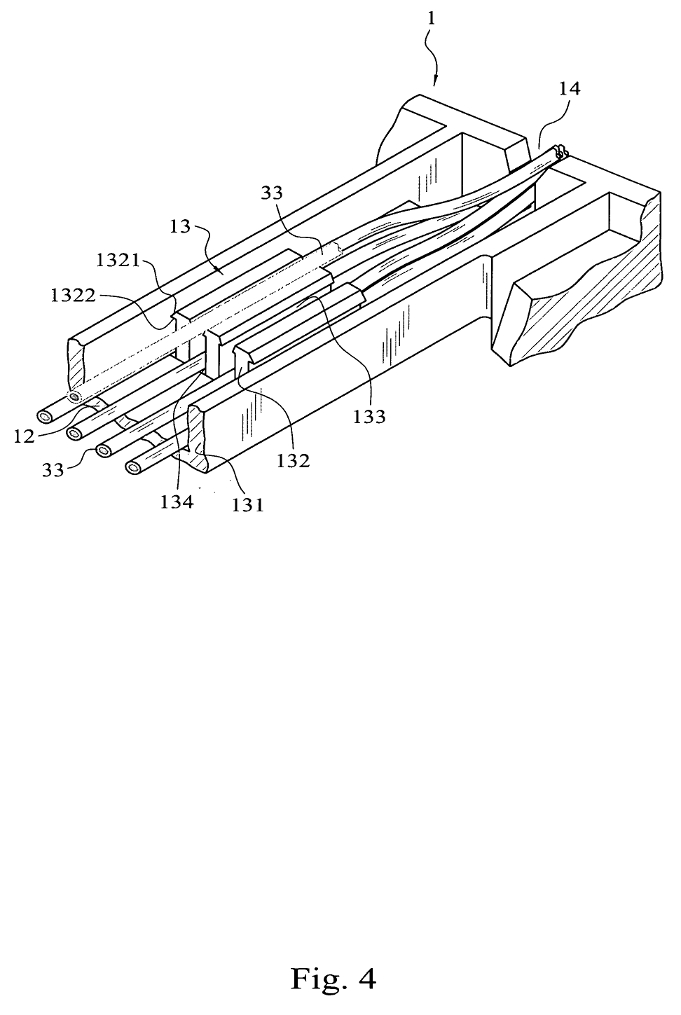

Please refer to FIG. 3 and FIG. 4. These drawings show the enlarged detail view of the part of the present invention labelled A-A in FIG. 2 and a view showing the collective-wire channel 13 of the present invention in use. The views show, that after the fan wheel 2 and the motor 3 are fitted onto the fan frame 1, the power cables 33 of the motor 3 will hang loosely on the outer surface of the fan frame 1. Now the collective-wire channel 13 mounted onto the desired area 12 between the fan frame 1 and the socket 11 can take in those power cables 33 of the motor 3. While the power cables 33 of the motor 3 are inserted into the collective-wire channel 13, these power cables 33 will be inserted into the openings 133 formed between the two side walls 131 and the securing walls 132 (or into the openings 133 formed between two securing walls 132). Over the bevels 1321 on the outer edge of the securing walls 132 the power cables 33 will slide smoothly into the restricted area 134 formed between the two side walls 131 and the securing walls 132 (or into the restricted area 134 formed between two securing walls 132). The hook-like surface 1322 formed through the bevels 1321 on the securing walls 132 will secure the power cables 33 in the restricted area 134. The power cables 33 which are thus restricted to the I collective-wire channel 13 will leave the fan frame 1 through the cable slit 14 (Not shown on picture). Therefore, through the use of the collective-wire channel 13 the power cables 33 can be easily inserted, fitted and secured inside of the collective-wire channel 13.

In summation of the foregoing section, the invention herein fully complies will all new patent application requirement and is hereby submitted to the patent bureau for review and granting of the commensurate patent rights.

The present invention may be embodied in other specific forms without departing from the spirit of the essential attributes thereof; therefore, the illustrated embodiment should be considered in all respects as illustrative and not restrictive, reference being made to the appended claims rather than to the foregoing description to indicate the scope of the invention.

What is claimed is:

1. A fan frame structure, the fan comprising a fan frame with a central part forming a socket, a fan wheel with a central axis, and a motor mounted on said socket, with the central hole taking in said central axis, providing at least one supporting part between said fan frame and said socket which used to fix the position of said socket on the central part of the fan frame, and the fan motor having stator attached to said socket and a rotor connected the axis of said fan wheel, characterized in that,
providing at least one collective-wire channel on one side of the supporting part of said fan frame, two side walls of said collective-wire channel protruding from said fan frame, with at least one fix-point column in between said side walls thereby said two side walls and at least one fix-point column to be arranged in regular distances, said collective-wire channel having openings in the free spaces between said two side walls and at least one fix-point column, said free spaces contained between two side walls and at least one fix-point column, forming one restricted area.

2. The fan frame structure according to claim 1, wherein both sides of the outer edge of said at least one fix-point column have bevels.

3. The fan frame structure according to claim 1, wherein both sides of the outer edge of said at least one fix-point column have bevels, through which a hook-like surface is formed towards said contained area.
